(19) United States
(12) Patent Application Publication
(10) Pub. No.: US 2025/0390297 A1
(43) Pub. Date: Dec. 25, 2025

(54) Electronic apparatus and firmware operation method thereof having firmware overlay mechanism

(71) Applicant: REALTEK SEMICONDUCTOR CORPORATION, HSINCHU (TW)

(72) Inventor: TSUNG-LI TSAI, Hsinchu (TW)

(21) Appl. No.: 19/240,023

(22) Filed: Jun. 17, 2025

(30) Foreign Application Priority Data
Jun. 19, 2024 (TW) 113122763

(51) Int. Cl. G06F 8/71; G06F 9/32; G06F 11/362

(52) U.S. Cl. CPC G06F 8/71; G06F 9/327; G06F 11/362

(57) ABSTRACT

The present disclosure an electronic apparatus having firmware overlay mechanism. A shared section of firmware and a first version section of the firmware corresponding to the first version firmware are retrieved from a firmware storage terminal to a memory circuit of a memory by a processing circuit. An address redirection process is performed on the first version firmware by an address decoding circuit of the memory to redirect first access addresses to physical addresses of the memory circuit. The first version firmware is executed through the address decoding circuit. A firmware version switching process is performed to retrieve a second version section of the firmware corresponding to the second version firmware to the memory circuit. The address re-defined process is performed on the second version firmware to redirect second access addresses to the physical addresses of the memory circuit. The second version firmware is executed through the address decoding circuit.

### BACKGROUND OF THE INVENTION

### 1. Field of the Invention

The present disclosure relates to an electronic apparatus and a firmware operation method thereof having a firmware overlay mechanism.

### 2. Description of Related Art

Firmware is a type of software embedded in the hardware apparatus and is configured to drive the hardware of such as, but not limited to peripheral apparatuses to operate accordingly. In order to enhance the efficiency of the hardware, the designers of the firmware update the version of the firmware.

However, in order to operate the hardware apparatus without constraint, the apparatus for providing the firmware needs to provide a plurality of versions of firmware with full contents therein such that the hardware apparatus operates according to the firmware corresponding to the most appropriate version. In some usage scenario, different versions of firmware may be switched depending on the requirements of the functions during the operation of the hardware apparatus. The issues of minimizing the storage space to accommodate different versions of firmware and keeping the accuracy of debugging performed on the firmware while the hardware apparatus in turn loads different versions of the firmware are critical for the designers.

### SUMMARY OF THE INVENTION

In consideration of the problem of the prior art, an object of the present disclosure is to provide an electronic apparatus and a firmware operation method thereof having a firmware overlay mechanism.

The present invention discloses an electronic apparatus having a firmware overlay mechanism that includes a storage circuit and a processing circuit. The storage circuit includes a memory circuit and an address decoding circuit. The processing circuit is configured to retrieve, from a firmware storage terminal, a shared section and a first version section corresponding to a first version firmware of a firmware file to the memory circuit, perform an address redirection process on the first version firmware by the address decoding circuit to redirect a plurality of first access addresses to a plurality of physical addresses of the memory circuit, access and execute the first version firmware through the address decoding circuit according to the first access addresses, perform a firmware version switching process to retrieve, from the firmware storage terminal, a second version section corresponding to a second version firmware of the firmware file to the memory circuit to replace the first version section, perform the address redirection process on the second version firmware by the address decoding circuit to redirect a plurality of second access addresses to the physical addresses of the memory circuit, wherein the second access addresses corresponding to the second version section are different from the first access addresses corresponding to the first version section and access and execute the second version firmware through the address decoding circuit according to the second access addresses.

The present invention also discloses a firmware operation method having a firmware overlay mechanism used in an electronic apparatus that includes steps outlined below. A shared section and a first version section corresponding to a first version firmware of a firmware file are retrieved from a firmware storage terminal to a memory circuit of a storage circuit by a processing circuit. An address redirection process is performed on the first version firmware by an address decoding circuit of the storage circuit to redirect a plurality of first access addresses to a plurality of physical addresses of the memory circuit. The first version firmware is accessed and executed through the address decoding circuit according to the first access addresses by the processing circuit. A firmware version switching process is performed to retrieve, from the firmware storage terminal, a second version section corresponding to a second version firmware of the firmware file to the memory circuit to replace the first version section by the processing circuit. The address redirection process is performed on the second version firmware by the address decoding circuit to redirect a plurality of second access addresses to the physical addresses of the memory circuit, wherein the second access addresses corresponding to the second version section are different from the first access addresses corresponding to the first version section. The second version firmware is accessed and executed through the address decoding circuit according to the second access addresses by the processing circuit.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 illustrates a block diagram of an electronic apparatus according to an embodiment of the present invention.

FIG. 2 illustrates a diagram of the firmware file according to an embodiment of the present invention.

FIG. 3 illustrates a detailed block diagram of the storage circuit according to an embodiment of the present invention.

FIG. 4A illustrates a diagram of the memory circuit storing the first version firmware according to an embodiment of the present invention.

FIG. 4B illustrates a diagram of the memory circuit storing the second version firmware according to an embodiment of the present invention.

FIG. 5A illustrates a function pointer table configured corresponding to the first version firmware according to an embodiment of the present invention.

FIG. 5B illustrates a function pointer table configured corresponding to the second version firmware according to an embodiment of the present invention.

FIG. 6 illustrates a block diagram of an electronic apparatus having a firmware overlay mechanism according to an embodiment of the present invention.

FIG. 7 illustrates a flow chart of a firmware operation method having a firmware overlay mechanism according to an embodiment of the present invention.

### DETAILED DESCRIPTION OF THE PREFERRED EMBODIMENTS

An aspect of the present invention is to provide an electronic apparatus and a firmware operation method thereof having a firmware overlay mechanism not only greatly decrease the memory space for storing firmware due to the shared firmware content and stores the firmware in a storage circuit having a faster access speed to increase the efficiency of a processing circuit, but also increase the debug accuracy according to the address relocation mechanism performed on memory blocks that store firmware section corresponding to different version.

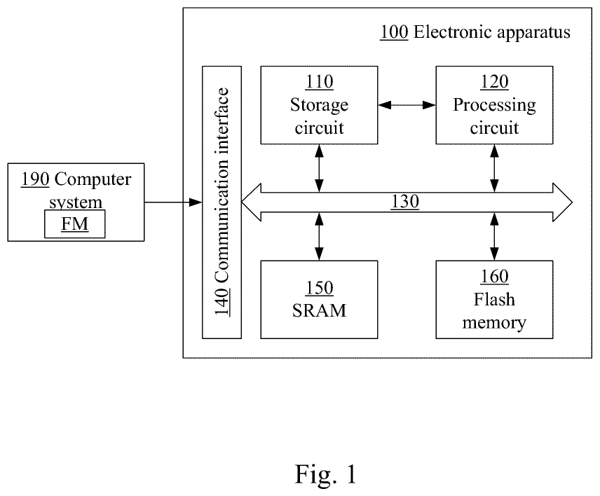

Reference is now made to FIG. 1. FIG. 1 illustrates a block diagram of an electronic apparatus 100 having according to an embodiment of the present invention. In an embodiment, the electronic apparatus 100 can be a peripheral apparatus coupled to a computer system 190, such as but not limited to a network interface card.

The electronic apparatus 100 includes a storage circuit 110, a processing circuit 120, an internal bus 130 and a communication interface 140. The processing circuit 120 may access the storage circuit 110 through the internal bus 130. The communication interface 140 can be interface of such as, but not limited to universal serial bus (USB) or peripheral component interconnect express (PCIe) and is configured to couple the internal bus 130 and the computer system 190, such that the processing circuit 120 performs communication with the communication interface 140 and the computer system 190 through the internal bus 130.

In an embodiment, the electronic apparatus 100 may include other components under the condition that the operation thereof is not affected. For example, the electronic apparatus 100 may selectively include a static random access memory (SRAM) 150 and a flash memory 160 to be accessed by the processing circuit 120 through the internal bus 130. The present invention is not limited thereto.

In the present embodiment, the computer system 190 is a firmware storage terminal that provides firmware file FM. In order to make the electronic apparatus 100 operate, the processing circuit 120 may retrieve the firmware file FM from the computer system 190 through such as, but not limited to the path formed by the communication interface 140 and the internal bus 130 described above to be stored in the storage circuit 110, so as to retrieve and execute the firmware content of the firmware file FM from the storage circuit 110.

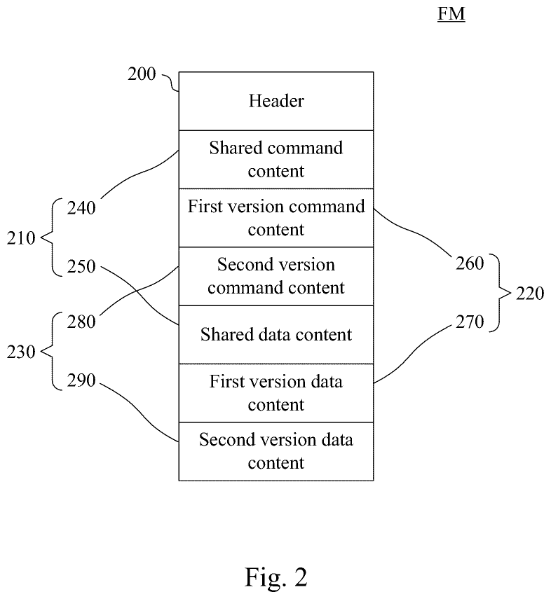

Reference is now made to FIG. 2. FIG. 2 illustrates a diagram of the firmware file FM according to an embodiment of the present invention.

In an embodiment, the firmware file FM includes a header 200, a shared section 210, a first version section 220 corresponding to the first version firmware and a second version section 230 corresponding to the second version firmware.

The header 200 includes information related to each of the shared section 210, the first version section 220 and the second version section 230, such that the processing circuit 120 in FIG. 1 reads the header 200 and accesses the content of each of the sections accordingly. In an embodiment, after being read, the header 200 is discarded without being stored in the electronic apparatus 100.

The shared section 210 is a section shared in the first version firmware and the second version firmware, in which the content thereof is the same in each of the different versions. In an embodiment, the shared section 210 includes a shared command content 240 and a shared data content 250, to respectively record commands and data related to the execution of the firmware of different versions.

The first version section 220 only corresponds to the first version firmware and includes a first version command content 260 and a first version data content 270 that respectively record commands and data related to the execution of the first version firmware. The second version section 230 only corresponds to the second version firmware and includes a second version command content 280 and a second version data content 290 that respectively record commands and data related to the execution of the second version firmware.

According to the configuration described above, the firmware file FM may include the firmware of two versions under the condition that the size of the file is minimized, without the need to include the full content of the firmware of the two versions. In a numerical example, when a size of the shared section 210 is 200 kilobyte (KB), a size of the first version section 220 is 100 KB and a size of the second version section 230 is 100 KB, the firmware including the full content of the two versions takes 600 KB to be stored. However, based on the configuration in FIG. 2, the firmware including the content of the two versions only takes 400 KB to be stored.

The storage circuit 110 in FIG. 1 has a configuration corresponding to the configuration of the firmware file FM such that the processing circuit 120 loads the firmware file FM of different versions according to the firmware overlay mechanism to be executed. The configuration of the storage circuit 110 and the operation of the processing circuit 120 are described in the following paragraphs to further describe the execution of the firmware overlay mechanism.

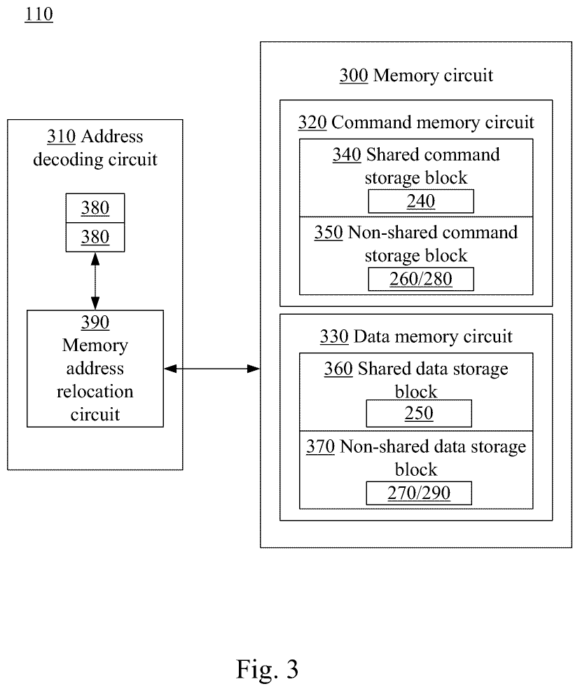

Reference is now made to FIG. 3. FIG. 3 illustrates a detailed block diagram of the storage circuit 110 according to an embodiment of the present invention. The storage circuit 110 includes a memory circuit 300 and an address decoding circuit 310.

The memory circuit 300 includes a command memory circuit 320 and a data memory circuit 330. In an embodiment, similar to a cache memory, the command memory circuit 320 and the data memory circuit 330 have a speed higher than the static random access memory 150 and the flash memory 160 to be accessed by the processing circuit 120 within such as, but not limited to a clock cycle.

The command memory circuit 320 includes a shared command storage block 340 and a non-shared command storage block 350. Corresponding to the firmware file FM in FIG. 2, the shared command storage block 340 is configured to store the shared command content 240 in the shared section 210. The non-shared command storage block 350 is configured to store the first version command content 260 of the first version section 220 corresponding to the first version firmware and store the second version command content 280 of the second version section 230 corresponding to the second version firmware.

The data memory circuit 330 includes a shared data storage block 360 and a non-shared data storage block 370. The shared data storage block 360 is configured to store the shared data content 250 of the shared section 210 corresponding to the firmware file FM in FIG. 2. The non-shared data storage block 370 is configured to store the first version data content 270 of the first version section 220 corresponding to the first version firmware and store the second version data content 290 of the second version section 230 corresponding to the second version firmware.

The address decoding circuit 310 is configured to access the memory circuit 300 according to the address provided by the processing circuit 110. In an embodiment, the address decoding circuit 310 includes a plurality of registers 380 and a memory address relocation circuit 390. According to the version of the firmware that is loaded, the memory address relocation circuit 390 performs an address redirection process on the memory circuit 300 and store the address relocation information in the registers 380.

Based on the configuration of the firmware file FM and the storage circuit 110 described above, the processing circuit 120 first retrieves the shared section 210 of the firmware file FM and the first version section 220 of corresponding to the first version firmware from the firmware storage terminal (e.g., the computer system 190) in FIG. 1) to the memory circuit 300.

In an embodiment, the electronic apparatus 100 serving as the peripheral apparatus performs the initialization of the processing circuit 120 first, configures the memory address relocation circuit 390 according to the required firmware version and waits for the computer system 190 serving as the firmware storage terminal to transmit the firmware file FM. Subsequently, the processing circuit 120 receives the header 200 from the computer system 190, configures the circuit of, such as but not limited to, a direct memory access (DMA) circuit (not illustrated in the figure) accordingly and further informs the computer system 190 that the processing circuit 120 is ready to receive the other part of the firmware file FM. Lastly, the computer system 190 transmits the shared section 210 and the first version section 220 according to the firmware version required by the electronic apparatus 100 to the electronic apparatus 100 to be stored with the use of the DMA circuit. The processing circuit 120 further sends report to the computer system 190 to inform the computer system 190 that the content transmitted therefrom is successfully received.

After retrieving the firmware file FM, the processing circuit 120 stores the shared command content 240 in the shared command storage block 340 of the memory circuit 300, stores the shared data content 250 in the shared data storage block 360 of the memory circuit 300, stores the first version command content 260 in the non-shared command storage block 350 of the memory circuit 300 and stores the first version data content 270 in the non-shared data storage block 370 of the memory circuit 300.

Subsequently, the address decoding circuit 310 performs an address redirection process on the first version firmware, so as to redirect a plurality of first access addresses to a plurality of physical addresses of the memory circuit 300.

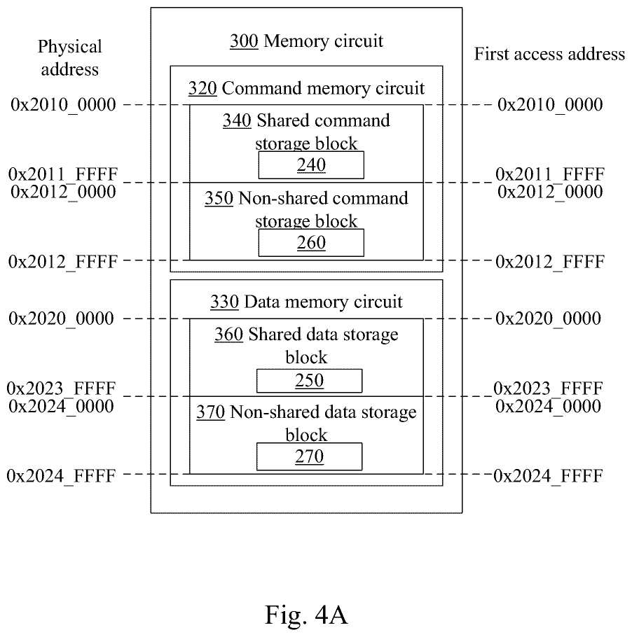

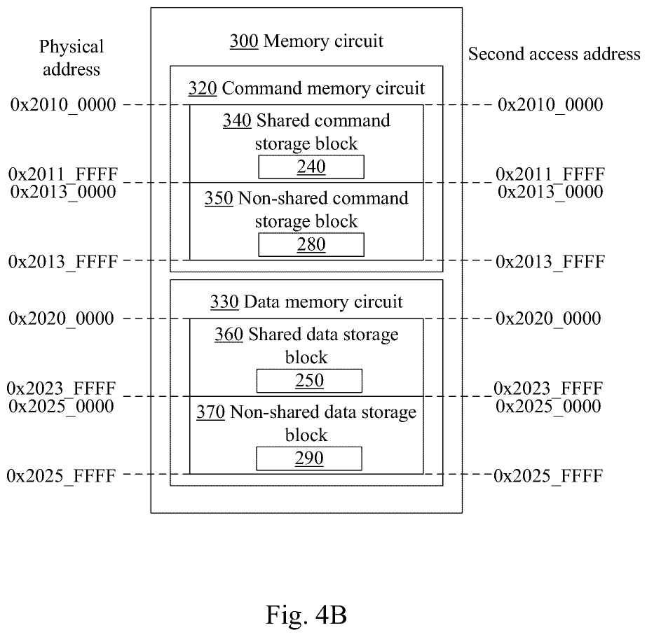

Reference is now made to FIG. 4A. FIG. 4A illustrates a diagram of the memory circuit 300 storing the first version firmware according to an embodiment of the present invention. In FIG. 4A, the physical addresses are labeled at a side of each of the storage blocks of the memory circuit 300, and the first access addresses are labeled at the other side of each of the storage blocks of the memory circuit 300.

In an embodiment, for the command memory circuit 320, the range of the physical addresses of the shared command storage block 340 is 0×2010_0000˜0×2011_FFFF, the range of the physical addresses of the non-shared command storage block 350 is 0×2012_0000˜0×2012_FFFF, the range of the physical addresses of the shared data storage block 360 is 0×2020_0000˜0×2023_FFFF, and the range of the physical addresses of the non-shared data storage block 370 is 0×2024_0000˜0×2024_FFFF.

The memory address relocation circuit 390 of the address decoding circuit 310 is configured to perform an address redirection process. In the present embodiment, the memory address relocation circuit 390 redirects the first access addresses in the range of 0×2010_0000˜0×2011_FFFF to the physical addresses of the shared command storage block 340. The memory address relocation circuit 390 redirects the first access addresses in the range of 0×2012_0000˜0×2012_FFFF to the physical addresses of the non-shared command storage block 350. The memory address relocation circuit 390 redirects the first access addresses in the range of 0×2020_0000˜0×2023_FFFF to the physical addresses of the shared data storage block 360. The memory address relocation circuit 390 redirects the first access addresses in the range of 0×2024_0000˜0×2024_FFFF to the physical addresses of the non-shared data storage block 370.

The memory address relocation circuit 390, corresponding to the first version firmware, further stores the first access addresses in the registers 380.

Under such a condition, the processing circuit 120 accesses and executes the first version firmware through the address decoding circuit 310 according to the first access addresses More specifically, when the first version firmware is executed, the processing circuit 120 delivers access commands to the storage circuit 110 according to the first access addresses. After analyzing the access commands, the address decoding circuit 310 of the storage circuit 110 discovers that the first access addresses are legit and redirects the first access addresses to the physical address to convert the first access addresses to the physical addresses to access the command or the data in the correct storage blocks and transmit the accessed content to the processing circuit 120 to execute the first version firmware. In an embodiment when the access addresses are not legit (e.g., the access addresses are not recorded in the address decoding circuit 310), the access commands are discarded.

The firmware version switching process is performed such that the processing circuit 120 retrieves the second version section 230 corresponding to the second version firmware in the firmware file from the firmware storage terminal in the memory circuit 110 to replace the first version section 220.

In an embodiment, either the electronic apparatus 100 serving as the peripheral apparatus or the computer system 190 serving as the firmware storage terminal can initial the firmware version switching process such that the firmware version switching process is performed when the processing circuit 120 determines that the commands corresponding to another version of firmware is required to be executed. Subsequently, the processing circuit 120 may suspend most of the tasks that is being processed, removes the memory usage and functions related to the first version firmware, and inform the computer system 190 that the firmware version switching mode is entered. The processing circuit 120 receives the header 200 from the computer system 190 and configure configures the circuit of, such as but not limited to, the DMA circuit accordingly and further informs the computer system 190 that the processing circuit 120 is ready to receive the other part of the firmware file FM. The computer system 190 transmits the second version section 230 according to the firmware version required by the electronic apparatus 100 to the electronic apparatus 100 to be stored with the use of the DMA circuit. The processing circuit 120 performs initialization and establishes new functions corresponding to the new version of the firmware and further sends report to the computer system 190 to inform the computer system 190 that the content transmitted therefrom is successfully received.

The processing circuit 120 does not retrieve the shared section 210 of the firmware file FM anymore. Moreover, the processing circuit 120 replaces the first version command content 260 by the second version command content 280 so as to be stored in the non-shared command storage block 350 of the memory circuit 300. The processing circuit 120 also replaces the first version data content 270 by the second version data content 290 so as to be stored in the non-shared data storage block 370 of the memory circuit 300.

Subsequently, the address decoding circuit 310, corresponding to the second version firmware, performs an address redirection process to redirect a plurality of second access addresses to a plurality of physical addresses of the memory circuit 300 to be mapped as a plurality of second access addresses. The second access addresses corresponding to second version section are different from the first access addresses corresponding to first version section.

Reference is now made to FIG. 4B. FIG. 4B illustrates a diagram of the memory circuit 300 storing the second version firmware according to an embodiment of the present invention. In FIG. 4B, the physical addresses are labeled at a side of each of the storage blocks of the memory circuit 300, and the second access addresses are labeled at the other side of each of the storage blocks of the memory circuit 300.

The memory address relocation circuit 390 of the address decoding circuit 310 is configured to perform an address redirection process. In an embodiment, the memory address relocation circuit 390 redirects the second access addresses in the range of 0×2010_0000˜0×2011_FFFF to the physical addresses of the shared command storage block 340. The memory address relocation circuit 390 redirects the second access addresses in the range of 0×2013_0000˜0×2013_FFFF to the physical addresses of the non-shared command storage block 350. The memory address relocation circuit 390 redirects the second access addresses in the range of 0×2020_0000˜0×2023_FFFF to the physical addresses of the shared data storage block 360. The memory address relocation circuit 390 redirects the second access addresses in the range of 0×2025_0000˜0×2025_FFFF to the physical addresses of the non-shared data storage block 370.

As a result, in the present embodiment, the first access addresses and the second access addresses of the non-shared command storage block 350 and the non-shared data storage block 370 are different. The first access addresses and the second access addresses of the shared command storage block 340 and the shared data storage block 360 are the same.

The memory address relocation circuit 390, corresponding to the second version firmware, further stores the second access addresses in the registers 380.

Under such a condition, the processing circuit 120 accesses and executes the second version firmware through the address decoding circuit 310 according to the second access addresses. More specifically, when the second version firmware is executed, the processing circuit 120 delivers access commands to the storage circuit 110 according to the second access addresses. After analyzing the access commands, the address decoding circuit 310 of the storage circuit 110 discovers that the second access addresses are legit and redirects the second access addresses to the physical address to convert the second access addresses to the physical addresses to access the command or the data in the correct storage blocks and transmit the accessed content to the processing circuit 120 to execute the second version firmware. In an embodiment when the access addresses are not legit (e.g., the access addresses are not recorded in the address decoding circuit 310), the access commands are discarded.

In some embodiments, corresponding to different versions of the firmware, the memory address relocation circuit 390 may set the first access addresses and the second access addresses of the shared command storage block 340 and the shared data storage block 360 to be different after the address redirection is performed. Moreover, in the embodiments described above, the condition that the first access addresses after mapping and the physical addresses are the same is used as an example. However, in some embodiments, the first access addresses after mapping can be different from the physical addresses. The present invention is not limited thereto.

It is appreciated that in some approaches, the address decoding circuit 310 maps the physical address of the memory circuit 300 to virtual addresses so as to be accessed by the processing circuit 120. Under such a condition, the address decoding circuit 310 may redirect the first access addresses and the second access addresses to the virtual addresses mapping to the physical addresses. The present invention is not limited thereto.

In an embodiment, the processing circuit 120 is configured to perform debug on the stored content in the non-shared command storage block 350 and the non-shared data storage block 370 according to the first access addresses and the second access addresses.

In some approaches, the non-shared command storage block 350 and the non-shared data storage block 370 do not have the address redirection mechanism and the access addresses thereof are configured to be the same. In some conditions, the processing circuit 120 may falsely determine the firmware version operated in the moment and is not able to perform debug correctly. Since the electronic apparatus of the present invention is equipped with the address redirection mechanism, the processing circuit 120 performs debug correctly according to different access addresses. The occurrence or error generated during the debug process can be greatly reduced.

In an embodiment, in order to execute a part of the firmware function call function, the shared data content 250 stored by the shared data storage block 360 in FIG. 3 includes a function pointer table such that the processing circuit 120 accesses the function pointer table to perform function call to execute the commands corresponding thereto.

However, function pointers stored in the function pointer table may be different depending on the different versions of the firmware. As a result, though the shared data content 250 is stored in the same block of the memory circuit 300 (e.g.., the shared data storage block 360) corresponding to different versions of the firmware, the function pointer table has different configurations in order to execute the different versions of firmware such that the processing circuit 120 is able to perform function call corresponding to the different versions of firmware.

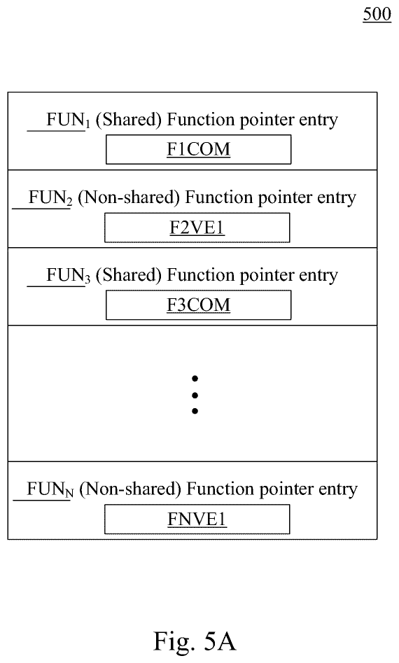

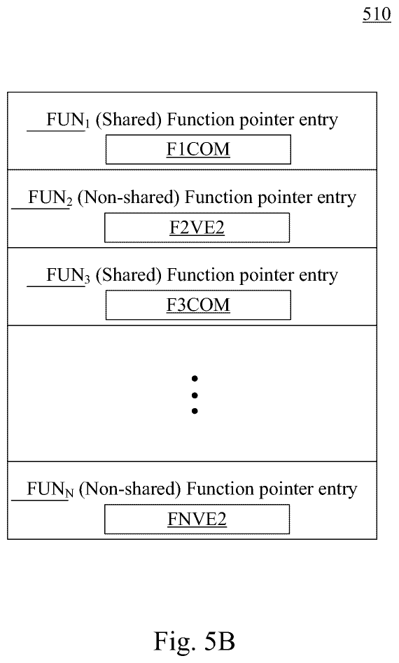

Reference is now made to FIG. 5A and FIG. 5B. FIG. 5A illustrates a function pointer table 500 configured corresponding to the first version firmware according to an embodiment of the present invention. FIG. 5B illustrates a function pointer table 510 configured corresponding to the second version firmware according to an embodiment of the present invention.

Each of the function pointer table 500 and the function pointer table 510 includes a plurality of function pointer entries FUN₁˜FUN_{N}. The function pointer entries FUN₁˜FUN_{N} include at least one shared function pointer entry and at least one non-shared function pointer entry. The shared function pointer entry and the non-shared function pointer entry include a function pointer of an interrupt handler (ISR) and/or a task handler (TSR).

In the present embodiment, the condition that the function pointer entry FUN₁ and the function pointer entry FUN₃ are the shared function pointer entries and the function pointer entry FUN₂ and the function pointer entry FUN_{N} are the non-shared function pointer entries is used as an example to describe the operation corresponding thereto.

The processing circuit 120 sets a shared function pointer in the function pointer entry FUN₁ and the function pointer entry FUN₃ that are the shared function pointer entries, and sets a first version function pointer corresponding to the first version firmware in the function pointer entry FUN₂ that is the non-shared function pointer entry, such that the processing circuit 120 performs a function call corresponding to the first version firmware.

As a result, as shown in FIG. 5A, the function pointer entry FUN₁ in the function pointer table 500 that is the shared function pointer entry stores a shared function pointer F1COM of a first function. The function pointer entry FUN₃ in the function pointer table 500 that is the shared function pointer entry stores a shared function pointer F3COM of a third function. The function pointer entry FUN₂ in the function pointer table 500 that is the non-shared function pointer entry stores a first version function pointer F2VE1 of a second function. The function pointer entry FUN_{N} in the function pointer table 500 that is the non-shared function pointer entry stores a first version function pointer FNVE1 of an N-th function.

On the other hand, when the firmware version switching process is performed, the processing circuit 120 sets a second version function pointer corresponding to the second version firmware in the non-shared function pointer entry such that the processing circuit 120 performs the function call corresponding to the second version firmware accordingly.

As a result, as shown in FIG. 5B, the function pointer entry FUN₁ in the function pointer table 510 that is the shared function pointer entry still stores the shared function pointer F1COM of the first function. The function pointer entry FUN₃ in the function pointer table 510 that is the shared function pointer entry still stores the shared function pointer F3COM of the third function. The function pointer entry FUN₂ in the function pointer table 510 that is the non-shared function pointer entry stores the second version function pointer F2VE2 of the second function. The function pointer entry FUN_{N} in the function pointer table 510 that is the non-shared function pointer entry stores the second version function pointer FNVE2 of the second function.

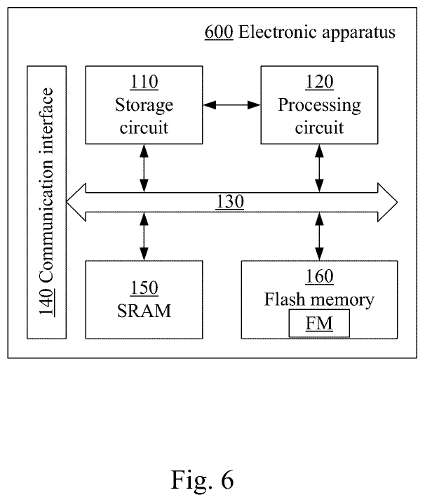

Reference is now made to FIG. 6. FIG. 6 illustrates a block diagram of an electronic apparatus 600 having a firmware overlay mechanism according to an embodiment of the present invention.

Similar to the electronic apparatus 100 in FIG. 1, the electronic apparatus 600 in FIG. 6 includes the storage circuit 110, the processing circuit 120, the internal bus 130, the communication interface 140, the static random access memory 150 and the flash memory 160. However, in an embodiment, the electronic apparatus 600 is a system on a chip (SoC) system and the flash memory 160 serves as the firmware storage terminal that provides the firmware file FM. The processing circuit 120 may retrieve the firmware file FM from the flash memory 160 through such as, but not limited to the internal bus 130 to be stored the storage circuit 110. The processing circuit 120 further retrieves and executes the firmware file FM from the storage circuit 110. The retrieving method and the storing method of the firmware file FM are identical to those described in the previous embodiments. The detail is not described herein.

Based on the embodiment described above, the electronic apparatus having the firmware overlay mechanism of the present invention not only greatly decrease the memory space for storing firmware due to the shared firmware content and stores the firmware in a storage circuit having a faster access speed to increase the efficiency of a processing circuit, but also increase the debug accuracy according to the address relocation mechanism performed on memory blocks that store firmware section corresponding to different version.

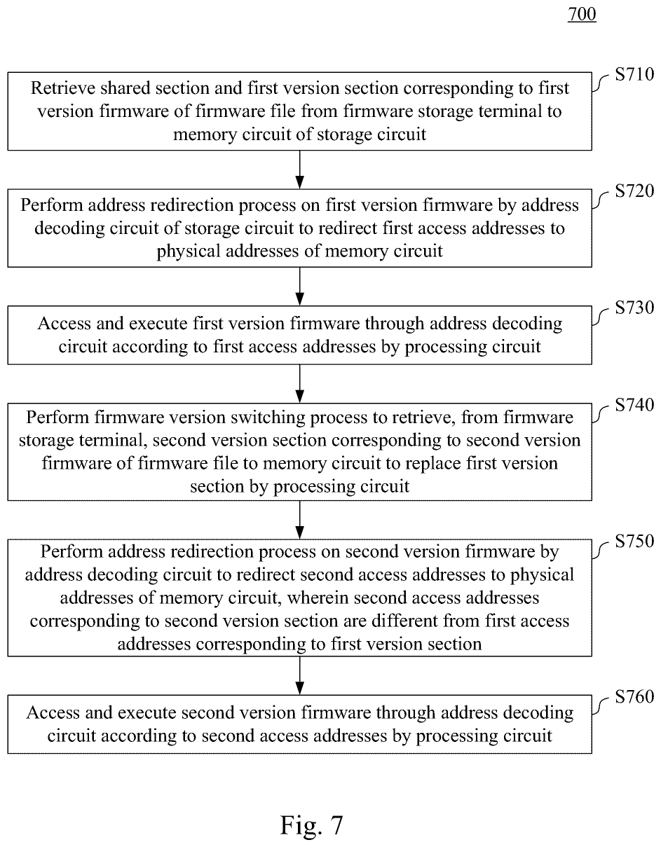

Reference is now made to FIG. 7. FIG. 7 illustrates a flow chart of a firmware operation method 700 having a firmware overlay mechanism according to an embodiment of the present invention.

Besides the apparatus described above, the present invention further discloses the firmware operation method 700 having the firmware overlay mechanism that can be used in such as, but not limited to the electronic apparatus 100 illustrated in FIG. 1. An embodiment of the firmware operation method 700 is illustrated in FIG. 7 and includes the steps outlined below.

In step S710, the shared section 210 and the first version section 220 corresponding to the first version firmware of the firmware file are retrieved from the firmware storage terminal to the memory circuit 300 of the storage circuit 110 by the processing circuit 120.

In step S720, the address redirection process is performed on the first version firmware by the address decoding circuit 310 of the storage circuit 110 to redirect the first access addresses to the physical addresses of the memory circuit 300.

In step S730, the first version firmware is accessed and executed through the address decoding circuit 310 according to the first access addresses by the processing circuit 120.

In step S740, the firmware version switching process is performed to retrieve, from the firmware storage terminal, the second version section 230 corresponding to the second version firmware of the firmware file to the memory circuit 300 to replace the first version section 220 by the processing circuit 120.

In step S750, the address redirection process is performed on the second version firmware by the address decoding circuit 310 to redirect the second access addresses to the physical addresses of the memory circuit 300, wherein the second access addresses corresponding to the second version section 230 are different from the first access addresses corresponding to the first version section 220.

In step S760, the second version firmware is accessed and executed through the address decoding circuit 310 according to the second access addresses by the processing circuit 120.

It is appreciated that the embodiments described above are merely an example. In other embodiments, it is appreciated that many modifications and changes may be made by those of ordinary skill in the art without departing, from the spirit of the invention. For example, the above embodiments are described based on the condition that the firmware file includes the content of two versions of firmware. In practical implementation, the firmware file may include the content of two and more than two versions of firmware such that the content of the firmware can be switched to the version of the firmware that is required to be operated. The present invention is not limited thereto.

In summary, the electronic apparatus and the firmware operation method thereof having the firmware overlay mechanism not only greatly decrease the memory space for storing firmware due to the shared firmware content and stores the firmware in a storage circuit having a faster access speed to increase the efficiency of a processing circuit, but also increase the debug accuracy according to the address relocation mechanism performed on memory blocks that store firmware section corresponding to different version.

The aforementioned descriptions represent merely the preferred embodiments of the present disclosure, without any intention to limit the scope of the present disclosure thereto. Various equivalent changes, alterations, or modifications based on the claims of present disclosure are all consequently viewed as being embraced by the scope of the present disclosure.

What is claimed is:

1. An electronic apparatus having a firmware overlay mechanism, comprising:
a storage circuit comprising a memory circuit and an address decoding circuit; and
a processing circuit configured to:
retrieve, from a firmware storage terminal, a shared section and a first version section corresponding to a first version firmware of a firmware file to the memory circuit;
perform an address redirection process on the first version firmware by the address decoding circuit to redirect a plurality of first access addresses to a plurality of physical addresses of the memory circuit;
access and execute the first version firmware through the address decoding circuit according to the first access addresses;
perform a firmware version switching process to retrieve, from the firmware storage terminal, a second version section corresponding to a second version firmware of the firmware file to the memory circuit to replace the first version section;
perform the address redirection process on the second version firmware by the address decoding circuit to redirect a plurality of second access addresses to the physical addresses of the memory circuit, wherein the second access addresses corresponding to the second version section are different from the first access addresses corresponding to the first version section; and
access and execute the second version firmware through the address decoding circuit according to the second access addresses.

2. The electronic apparatus of claim 1, wherein the memory circuit comprising:
a command memory circuit comprising:
a shared command storage block configured to store a shared command content of the shared section; and
a non-shared command storage block configured to store a first version command content of the first version section corresponding to the first version firmware and store a second version command content of the second version section corresponding to the second version firmware; and
a data memory circuit comprising:
a shared data storage block configured to store a shared data content of the shared section; and
a non-shared data storage block configured to store a first version data content of the first version section corresponding to the first version firmware and store a second version data content of the second version section corresponding to the second version firmware;
wherein the first access addresses and the second access addresses of the non-shared command storage block and the non-shared data storage block are different, and the first access addresses and the second access addresses of the shared command storage block and the shared data storage block are the same.

3. The electronic apparatus of claim 2, wherein the shared data content comprising a function pointer table, the function pointer table comprising at least one shared function pointer entry and at least one non-shared function pointer entry, the processing circuit is further configured to:
set at least one shared function pointer in the at least one shared function pointer entry and set at least one first version function pointer corresponding to the first version firmware in the at least one non-shared function pointer entry, such that the processing circuit performs a function call corresponding to the first version firmware accordingly; and
when the firmware version switching process is performed, set at least one second version function pointer corresponding to the second version firmware in the at least one non-shared function pointer entry, such that the processing circuit performs the function call corresponding to the second version firmware accordingly.

4. The electronic apparatus of claim 3, wherein the at least one shared function pointer entry and the at least one non-shared function pointer entry comprises a function pointer of an interrupt handler (ISR) and/or a task handler (TSR).

5. The electronic apparatus of claim 2, wherein the processing circuit configured to perform a debug process on the non-shared command storage block and the non-shared data storage block according to the first access addresses and the second access addresses.

6. The electronic apparatus of claim 1, wherein the address decoding circuit comprising:
a plurality of registers; and
a memory address relocation circuit configured to perform an address redirection process, store the first access addresses corresponding to the first version firmware in the registers, and store the second access addresses corresponding to the second version firmware in the registers.

7. The electronic apparatus of claim 1, wherein the firmware storage terminal is a computer system coupled to the electronic apparatus or a flash memory further comprised by the electronic apparatus.

8. A firmware operation method having a firmware overlay mechanism used in an electronic apparatus, comprising:
retrieving, from a firmware storage terminal, a shared section and a first version section corresponding to a first version firmware of a firmware file to a memory circuit of a storage circuit by a processing circuit;
perform an address redirection process on the first version firmware by an address decoding circuit of the storage circuit to redirect a plurality of first access addresses to a plurality of physical addresses of the memory circuit;
accessing and executing the first version firmware through the address decoding circuit according to the first access addresses by the processing circuit;
performing a firmware version switching process to retrieve, from the firmware storage terminal, a second version section corresponding to a second version firmware of the firmware file to the memory circuit to replace the first version section by the processing circuit;
performing the address redirection process on the second version firmware by the address decoding circuit to redirect a plurality of second access addresses to the physical addresses of the memory circuit, wherein the second access addresses corresponding to the second version section are different from the first access addresses corresponding to the first version section; and
accessing and executing the second version firmware through the address decoding circuit according to the second access addresses by the processing circuit.

9. The firmware operation method of claim 8, further comprising:
storing a shared command content of the shared section by a shared command storage block comprised by a command memory circuit of the memory circuit;
storing a first version command content of the first version section corresponding to the first version firmware and storing a second version command content of the second version section corresponding to the second version firmware by a non-shared command storage block comprised by the command memory circuit;
storing a shared data content of the shared section by a shared data storage block comprised by a data memory circuit of the memory circuit; and
storing a first version data content of the first version section corresponding to the first version firmware and storing a second version data content of the second version section corresponding to the second version firmware by a non-shared data storage block comprised by the data memory circuit;
wherein the first access addresses and the second access addresses of the non-shared command storage block and the non-shared data storage block are different, and the first access addresses and the second access addresses of the shared command storage block and the shared data storage block are the same.

10. The firmware operation method of claim 9, wherein the shared data content comprising a function pointer table, the function pointer table comprising at least one shared function pointer entry and at least one non-shared function pointer entry, the firmware operation method further comprising:
setting at least one shared function pointer in the at least one shared function pointer entry and setting at least one first version function pointer corresponding to the first version firmware in the at least one non-shared function pointer entry by the processing circuit, such that the processing circuit performs a function call corresponding to the first version firmware accordingly; and
when the firmware version switching process is performed, setting at least one second version function pointer corresponding to the second version firmware in the at least one non-shared function pointer entry by the processing circuit, such that the processing circuit performs the function call corresponding to the second version firmware accordingly.

11. The firmware operation method of claim 10, wherein the at least one shared function pointer entry and the at least one non-shared function pointer entry comprises a function pointer of an interrupt handler and/or a task handler.

12. The firmware operation method of claim 9, further comprising:
performing a debug process on the non-shared command storage block and the non-shared data storage block according to the first access addresses and the second access addresses by the processing circuit.

13. The firmware operation method of claim 8, further comprising:
performing an address redirection process, storing the first access addresses corresponding to the first version firmware in a plurality of registers, and storing the second access addresses corresponding to the second version firmware in the registers by a memory address relocation circuit comprised by the address decoding circuit.

14. The firmware operation method of claim 8, wherein the firmware storage terminal is a computer system coupled to the electronic apparatus or a flash memory further comprised by the electronic apparatus.
